(19) United States
(12) Patent Application Publication
(10) Pub. No.: US 2026/0250612 A1
(43) Pub. Date: Aug. 27, 2026

(54) METHOD FOR REMOVING UNDESIRED SUBSTANCES FROM WORT AND PROCESS EQUIPMENT FOR BEER PRODUCTION

(71) Applicant: FRANK INNOVATION APS, Abyhoj (DK)

(72) Inventor: William Frank, Abyhoj (DK)

(21) Appl. No.: 19/163,536

(22) PCT Filed: Jan. 11, 2024
(86) PCT No.: PCT/EP2024/050583

§ 371 Date: Sep. 9, 2025

(30) Foreign Application Priority Data
Mar. 19, 2023 (DK) PA202300244
Oct. 25, 2023 (DK) PA202330288

(51) Int. Cl. C12C 7/24; C12C 7/22; C12C 13/08

(52) U.S. Cl. CPC C12C 7/24; C12C 7/22; C12C 13/08

(57) ABSTRACT

The present invention relates to a method for removing undesired volatile substances from wort for beer production. The method comprises subjecting a produced wort to a boiling and hopping process; and transporting the boiled and flavored wort towards a whirlpool tank via a pipe system. A stripping gas is introduced into a first part of the pipe system to mix with the wort flowing therethrough. The stripping gas, now mixed with stripped volatile substances, is then removed either at a second part of the pipe system positioned downstream to the first part of pipe system, and/or removed from the whirlpool tank.

### TECHNICAL FIELD OF THE INVENTION

The present invention relates to beer production.

### BACKGROUND OF THE INVENTION

### Wort Cooking

In the brewhouse, malt, hops, and other raw materials are converted to beer wort during boiling. The wort contains the elements that are fermented to beer. The beer wort also comprises the volatile compound dimethyl sulfide (DMS) that plays a negative role in the flavor profile of the final product. DMS tastes and smells like a cooked mixture of maize and vegetables. DMS is primarily formed from the thermal decomposition of S-methylmethionine (SMM) during kilning of the barley used for malting.

### Problems Related to DMS when Using a Whirlpool Tank

During kilning, SMM is converted into DMS when the barley is heated, which is why DMS levels can be influenced by the malt drying process. In addition to DMS, the barley contains DMS precursors, these are called DMS-P. The precursors are water soluble and as such also soluble in beer wort. DMS-P are converted to DMS at high temperatures. The thermal decomposition of DMS is a 1st order reaction with a half-life of 80 minutes at 100° C. and 747 minutes at 80° C.

For many types of malt, the DMS evaporates during the drying process, but when producing pilsner malt and other pale malts, the drying process is so gentle that a larger amount of DMS and DMS-P normally remains in the malt. Therefore, it might be necessary to reduce the amount of the components in the beer wort, when brewing pilsner or other beer types primarily based on pilsner malt and pale malts.

Before the introduction of whirlpool tanks as an economic advantageous solution for removal of hot trub and hop residues, DMS was not a problem for the breweries. With a processing time of around two hours in a whirlpool tank and without a driving force (cooking) for removal of DMS, the formation of DMS from precursors can cause that it is possible to taste DMS as an off-flavor in the finished beer. To avoid this, it is necessary to cook the beer wort in the wort kettle until precursors for DMS are converted to DMS and evaporated before the beer wort is pumped into the whirlpool. Alternatively, the cooking time can be reduced and simultaneously a content of DMS is accepted in the finished beer, where the DMS off flavor might be possible to taste.

### Issues around DMS during “Hight Temperature Wort Boiling”

In an exemplary process of High Temperature Wort Boiling (there might be variations in pressure, temperature, and numbers of heat exchangers), the wort is collected from the lauter vessel to a collecting vessel where hops are added. Hereafter the pressure is increased by pumping to about 6 Bar, and the hot wort is stepwise heated to 140° C. with three heat exchangers and kept at 140° C. for around 5 minutes in the holding zone. The holding zone is usually constructed as a coil. After treatment the pressure on the wort is relieved, usually in 2 pressure relief tanks, whereafter it is delivered to the whirlpool at atmospheric pressure.

At 140° C. the alfa-acids in the hops are isomerized within 5 minutes and almost all DMS-P is converted to DMS.

The advantage of the process is that it is fast, and the wort is not oxidized.

The disadvantage is that the amount of DMS and other volatile components in the finished beer wort will normally be high. Due to the DMS-issue the High Temperature Boiling process is not used. The process has the economic advantage that it is going on in a coil system, and that the capacity basically just need to follow the output from the lauter tun. This results in essential savings in energy and construction costs.

### Known Technique Krones GmbH

Krones GmbH has developed a technology for removal of DMS from the finished wort after the whirlpool. With the Krones technology the wort is led as a falling film in a countercurrent with CO2. The solution has the disadvantage that extra brewing equipment must be installed after the whirlpool in the brewery.

### Known Technique WO 99/06525 A2 Anton Steinecker Maschinenfabrik GMBH

A process of stripping Dimethylsulphide (DMS) from beer wort is described, including a step, where Nitrogen (N2) and/or Carbon dioxide (CO2) is blown into the wort after the whirlpool, followed by a step, where DMS can be separated in a separate container.

### Known Technique DE 102008056795 A1 GEA Brewery Systems GMBH

A process of stripping Dimethylsulphide (DMS) from beer wort is described, including a step, where Nitrogen (N2) and/or Carbon dioxide (CO2) is blown into the wort after the whirlpool, followed by a step, where DMS can be separated in a separate container.

### SUMMARY OF THE INVENTION

It is an object of the present invention to provide a reduction of the process time in the brew house, and a reduced energy consumption of the process.

The applicant has found that the content of DMS can be reduced in a simple and effective way by blowing a stripping gas directly into the hot wort line during hot wort transportation from the wort kettle to the whirlpool tank, why the boiling time of the wort can be reduced.

The advantages of the present invention will be a reduction of the process time in the brew house and a reduced energy consumption. Both with significant positive economic and environmental advantages. Furthermore, stripping of the hot wort with CO₂ will result in the removal of oxygen introduced into the wort during processing, leading to an increased sensory shelf life and quality of the finished beer.

A first aspect relates to a method for removing undesired volatile substances from wort, comprising:
producing a mash from milled malt in a mash tun;
transporting the mash from the mash tun to a lauther tun to remove solid remains of the milled malt, thereby obtaining a wort;
subjecting the wort from the lauter tun to a boiling and hopping process; and
transporting the boiled and flavored wort towards a whirlpool tank via a pipe system;
   wherein a stripping gas is introduced into a first part of said pipe system to mix with said wort flowing through said pipe system, and wherein said stripping gas mixed with stripped volatile substances is removed either at a second part of said pipe system positioned downstream to said first part of pipe system, and/or removed from the whirlpool tank.

Another aspect relates to a method for removing undesired volatile substances from wort, comprising:
optionally producing a mash from milled malt in a mash tun;
optionally transporting the mash from the mash tun to a lauther tun to remove solid remains of the milled malt, thereby obtaining a wort;
subjecting a produced wort, preferably obtained from a lauter tun, to a boiling and hopping process; and
transporting the boiled and flavored wort towards a whirlpool tank via a pipe system;
   wherein a stripping gas is introduced into a first part of said pipe system to mix with said wort flowing through said pipe system, and wherein said stripping gas mixed with stripped volatile substances is removed either at a second part of said pipe system positioned downstream to said first part of pipe system, and/or removed from the whirlpool tank.

A second aspect relates to a beer processing system comprising:
a mash tun;
a lauther tun;
a wort boiling apparatus; and
a whirlpool tank;
   wherein the wort boiling apparatus is in liquid (wort) communication with the whirlpool tank via a pipe system;
   wherein the beer processing system further comprises a stripping gas unit in stripping gas communication with said pipe system.

Another aspect relates to a beer processing system comprising:
optionally a mash tun;
optionally a lauther tun;
a wort boiling apparatus; and
a whirlpool tank;
   wherein the wort boiling apparatus is in liquid (wort) communication with the whirlpool tank via a pipe system;
   wherein the beer processing system further comprises a stripping gas unit in stripping gas communication with said pipe system.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1 is a schematic illustration of a process equipment in accordance with the present invention.

### DETAILED DESCRIPTION OF THE INVENTION

As said, dimethyl sulfide (DMS) is a compound that is present in wort and beer, and it plays a negative role in the flavor profile of the final product. However, it can be problematic if not properly managed. DMS originates from the malt. It is primarily formed from the thermal decomposition of S-methylmethionine (SMM) during kilning. SMM is converted into DMS when heated, which is why DMS levels can be influenced by the malt drying process.

Industrial beer production is a complex and carefully controlled process that transforms basic ingredients into the final product enjoyed by consumers worldwide. The process begins with malt production at a malting facility, where barley grains are malted through a process of soaking, germination, and drying. This malting develops enzymes necessary for converting starches in the grains into fermentable sugars. The malted barley is then dried (kilning) to form the malt's properties (such as color, flavor, and aroma), and to improve its shelf life- and is then transported to silos for storage.

The kilning process is an essential step in the malt production and involves drying malted barley grains to stop the germination process and to develop the desired malt characteristics based on color, flavor, and aroma. Before kilning, barley grains undergo germination. During this stage, the grains are soaked in water and allowed to sprout. This process activates enzymes in the grains that convert starches into fermentable sugars and unfermentable compounds that contributes to the fullness of the beer's flavor. After about 5-6 days of germination, the rootlets are removed from the sprouted grains, now called green malt, and is then transferred to a kiln. This transfer happens at a critical point where enough enzyme activity has occurred but before the grain sprouts grow too long. The initial phase of kilning is a gentle drying process. The green malt is spread out in a thin layer in the kiln and is slowly dried at low temperatures (usually around 30-50° C.). This gradual drying prevents the destruction of the enzymes needed for the brewing process. After the moisture content is sufficiently reduced, the temperature is gradually increased. This curing phase is where the character of the malt is developed. Different temperatures and durations are used depending on the type of malt being produced. For pale malts, temperatures are kept relatively low (around 80° C.). For darker malts, higher temperatures (up to 220° C.) are used, which creates more roasted flavors and darker colors. Once the desired color and flavor profile is achieved, the malt is cooled down to stop the kilning process.

The milled malt is mixed with hot water in a process called mashing. In the mash tun, this mixture activates enzymes that convert the starches into a sugary liquid known as wort. After mashing, the wort is separated from the solid remains of the malt in a process called lautering. The solids, referred to as spent grains, are often repurposed, commonly as animal feed. The spent grains are largely the husks and other grain residues.

The wort is then transferred to a boiling vessel where it is boiled (either in a traditional wort kettle (that may be configured in many ways) or using a method known as High Temperature Wort Boiling), during which step the hops are added. Hops are crucial for adding bitterness, flavor, and aroma to the beer. The boiling of wort is a critical step in reducing DMS levels. DMS is volatile at boiling temperatures, so a vigorous and prolonged boil can help evaporate much of the DMS present in the wort. Additionally, precursors to DMS will be converted to DMS, why the prolonged boiling reduces both the content of DMS and its precursors. Inadequate boiling can result in higher levels of DMS in the finished beer. The boiling process also serves to sterilize the wort and concentrate its flavors. DMS imparts a distinct aroma and flavor often described as cooked corn or vegetable-like. While low levels of DMS can be acceptable in certain beer styles (like some lagers), higher concentrations are off-putting and are generally considered a flaw in most beer styles. As it is an object of the present invention to provide a reduction of the process time in the brew house, and a reduced energy consumption of the process, the boiling time is a focus area to reduce. Hence, the DMS will have to be removed with different means.

Once boiling is complete, the wort is transported to a whirlpool tank. In the whirlpool tank, the wort is swirled, allowing solid particles, such as hop residue (including hops-resin complexes) and coagulated proteins, to settle. This clarifies the wort before it is further filtered, temperature regulated, and transferred to fermentation tanks (either traditional fermentation tanks or cylindrical conical tanks).

The inventor of the present invention has found that the content of DMS can be reduced in a simple and effective way by blowing a stripping gas directly into the hot wort line during hot wort transportation from the wort kettle to the whirlpool tank. When injecting through e.g., a valve or nozzle introduced into the hot wort line, a complete mixing of the hot wort and the stripping gas is accomplished. The injected stripping gas, now containing DMS and other unwanted volatile compounds, can be collected (also for reuse) directly from the hot wort pipe system, or it can be transported to the whirlpool tank and released there. Depending on the stripping gas intake speed, the removal of DMS can be regulated. At a temperature just below 100 degrees Celsius, and during intensive mixing of wort and stripping gas, a 50% reduction of the DMS amount is obtained within 15 minutes at the end of the hot wort pipe system using a wort where the boiling time had been performed for 30 minutes. This result has e.g., been shown by using 400 gram of carbon dioxide (CO₂) per hectoliter hot wort in a test system of three hectoliters (hl). Correspondingly, a 70% reduction of DMS has been obtained in an industrial 10 hl facility when pumping the hot wort from the wort kettle to the whirlpool tank for a period of eight minutes. In this case, the same relative amount of CO₂ was added immediately after the wort kettle. The hot wort pipe system spanned 18 meters after the CO₂ inlet (valve or nozzle). The wort boiling time was performed for 30 minutes. The resulting stripped wort was subsequently used for beer production and bottled. The resulting beer (a pilsner type) was taste evaluated after two weeks and compared to commercial products. The result was a beer with a relatively more fresh and clean taste, and with the usual taste characteristics.

The use of CO₂ for stripping of hot wort in the hot wort line will have advantages in breweries that reuse their CO₂, as the CO₂ from stripping in a simple way can be collected, rinsed/compressed, and reused.

The advantages of the present invention will be a reduction of the process time in the brew house and a reduced energy consumption. Both with significant positive economic and environmental advantages. Furthermore, stripping of the hot wort with CO₂ will result in the removal of oxygen introduced into the wort during processing, leading to an increased sensory shelf life and quality of the finished beer.

A first aspect relates to a method for removing undesired volatile substances from wort, the method comprising:
producing a mash from milled malt in a mash tun;
transporting the mash from the mash tun to a lauther tun to remove solid remains of the milled malt, thereby obtaining a wort;
subjecting the wort from the lauter tun to a boiling and hopping process; and
transporting the boiled and flavored wort towards a whirlpool tank via a pipe system;
   wherein a stripping gas selected from carbon dioxide gas, nitrogen, inert gasses, or mixtures thereof is introduced into a first part of said pipe system to mix with said wort flowing through said pipe system, and wherein said stripping gas mixed with stripped volatile substances is removed either at a second part of said pipe system positioned downstream to said first part of pipe system, and/or removed from the whirlpool tank.

Another aspect relates to a method for removing undesired volatile substances from wort, comprising:
optionally producing a mash from milled malt in a mash tun;
optionally transporting the mash from the mash tun to a lauther tun to remove solid remains of the milled malt, thereby obtaining a wort;
subjecting a produced wort, preferably obtained from a lauter tun, to a boiling and hopping process; and
transporting the boiled and flavored wort towards a whirlpool tank via a pipe system;
   wherein a stripping gas is introduced into a first part of said pipe system to mix with said wort flowing through said pipe system, and wherein said stripping gas mixed with stripped volatile substances is removed either at a second part of said pipe system positioned downstream to said first part of pipe system, and/or removed from the whirlpool tank.

A second aspect relates to a beer processing system comprising:
a mash tun;
a lauther tun;
a wort boiling apparatus; and
a whirlpool tank;
   wherein the wort boiling apparatus is in liquid (wort) communication with the whirlpool tank via a pipe system;
   wherein the beer processing system further comprises a stripping gas unit in stripping gas communication with said pipe system.

Another aspect relates to a beer processing system comprising:
optionally a mash tun;
optionally a lauther tun;
a wort boiling apparatus; and
a whirlpool tank;
   wherein the wort boiling apparatus is in liquid (wort) communication with the whirlpool tank via a pipe system;
   wherein the beer processing system further comprises a stripping gas unit in stripping gas communication with said pipe system.

Yeast is then added to the cooled wort, initiating the fermentation process. During fermentation, yeast converts the sugars in the wort into alcohol and carbon dioxide, creating beer. This beer is then matured in conditioning tanks, a step that allows the beer to develop its full flavor profile.

Alternatively, and perhaps as commonly, the fermentation process and the conditioning process is performed in the same tank, a cylindrical conical tank.

Following maturation, the beer is normally filtered to remove any residual yeast or particulates and carbonated if the natural carbonation from fermentation is insufficient.

In one or more embodiments, the boiling process is performed in a wort kettle or coil. In a conventional wort kettle, the wort is heated to a rolling boil, typically around 100° C., using e.g., steam jackets or direct heat. As said, this boiling process serves multiple purposes, such as sterilization of the wort, stopping of enzymatic activity, isomerization of the hops, extraction of bitterness from the hops, evaporation of unwanted volatile compounds, and coagulation of proteins for easier removal. The boiling usually lasts between 60 to 90 minutes, depending on the beer style and brewer's preference. Traditional boiling is less energy-efficient due to the large amount of heat required to maintain the wort at boiling temperature. Therefore, several different boiling systems have been developed around a central wort boiler with the purpose of reducing the energy consumption.

In one or more embodiments, the boiling process is performed by High Temperature Wort Boiling (HTWB). HTWB involves boiling the wort at temperatures much higher (typically at about 140 degrees Celsius) than the normal boiling point of water, achieved under pressure in a closed system. This method enhances the extraction of hop bitterness. It can also lead to a clearer wort by promoting better coagulation of proteins.

The boiling time will be much shorter in HTWB compared to traditional methods because the higher temperatures accelerate the necessary physical processes. HTWB is more energy efficient as it requires less time and can utilize heat recovery systems more effectively. A condenser is used to cool down the wort after boiling and to reduce the pressure. This also helps in recovering some of the energy used in the boiling process, improving overall efficiency. The most essential part of HTWB is a zone shaped as a coil, where the boiling processes are done within a few minutes. The wort is heated upstream to the coil in a system of heat exchangers, and downstream to the coil, the pressure is reduced (typically in two steps).

In one or more embodiments, at least a part of the pipe system is configured as a coil. This configuration provides for more turbulence within the pipe system, thereby allowing the stripping gas to mix better with the wort. The inventor, based on theoretical considerations, expects that the stripping gas bubbles will be smaller when more turbulence is generated.

In beer production, minimizing oxygen uptake is crucial to avoid oxidation, which can affect flavor and stability. Therefore, inert gases are preferred. Additionally, the compatibility of the gas with the existing equipment and its overall impact on the production cost and efficiency are also important considerations.

In one or more embodiments, the stripping gas is selected from the group consisting of carbon dioxide gas, nitrogen gas, inert gasses, and mixtures thereof. Nitrogen (N₂) is inert, non-reactive, and widely used in the food industry. It's particularly useful for removing oxygen and other volatile compounds without affecting the flavor or quality of the product. Carbon dioxide (CO₂) is naturally produced during fermentation, so additional CO₂ can be used in the stripping process. Argon and helium are other examples of inert gas that can be used for stripping. They are less commonly used than nitrogen due to their higher cost but can be used in similar applications.

In one or more embodiments, the wort boiling apparatus comprises a wort kettle or coil, e.g., equipped with either an external or internal boiler.

In one or more embodiments, the wort boiling apparatus comprises a High Temperature Wort Boiling kettle or coil, preferably comprising a heating coil.

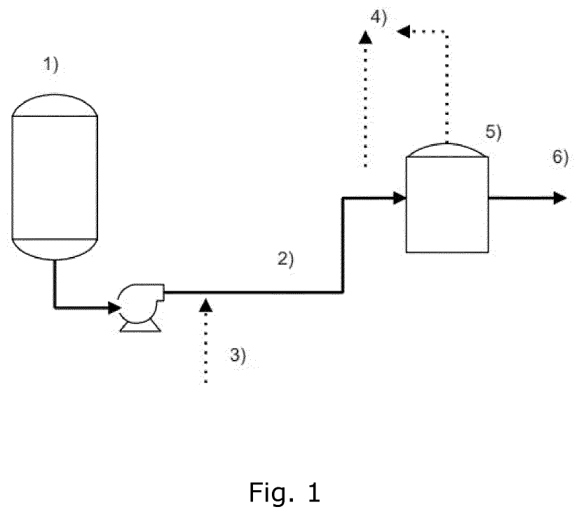

FIG. 1 is a schematic illustration of a process equipment in accordance with the present invention. Here, the boiled and flavored wort is transported from a wort collection vessel 1 towards a whirlpool tank 5 via a pipe system A stripping gas is introduced into a first part of the pipe system 2 via a stripping gas inlet 3 to mix with the wort flowing therethrough. The stripping gas mixed with stripped volatile substances 4, such as DMS, is removed either at a second part of the pipe system 2 positioned downstream to the first part of pipe system 2, and/or removed from the whirlpool tank. The wort, now purified from stripped volatile substances, hot trub, and hop residues, is now transported away from the whirlpool tank 5 to an apparatus cooling 6.

### REFERENCES

1 Wort collection vessel
2 Pipe system
3 Gas inlet
4 Stripping gas mixed with stripped volatile substances
5 Whirlpool tank
6 Apparatus for cooling purified wort

1. A method for removing undesired volatile substances from wort, the method comprising:
subjecting a produced wort to a boiling and hopping process; and
transporting the boiled and flavored wort towards a whirlpool tank via a pipe system;
wherein a stripping gas is introduced into a first part of said pipe system to mix with said wort flowing through said pipe system, and wherein said stripping gas mixed with stripped volatile substances is removed either at a second part of said pipe system positioned downstream to said first part of pipe system, and/or removed from the whirlpool tank.

2. The method according to claim 1, wherein the boiling process is performed in a wort kettle or coil.

3. The method according to claim 1, wherein the boiling process is performed by High Temperature Wort Boiling.

4. The method according to claim 1, wherein the stripping gas is selected from the group consisting of carbon dioxide gas, nitrogen gas, inert gasses, and mixtures thereof.

5. A beer processing system comprising:
a wort boiling apparatus; and
a whirlpool tank;
wherein the wort boiling apparatus is in liquid communication with the whirlpool tank via a pipe system;
characterized in that the beer processing system further comprises a stripping gas unit in stripping gas communication with said pipe system.

6. The beer processing system according to claim 5, further comprising:
a mash tun; and
a lauther tun.

7. The beer processing system according to claim 5, wherein the stripping gas is introduced into a first part of said pipe system to mix with the wort flowing through the pipe system, and wherein said stripping gas mixed with stripped volatile substances is removed either at a second part of said pipe system positioned downstream to said first part of pipe system, and/or removed from the whirlpool tank.

8. The beer processing system according to claim 5, wherein at least a part of the pipe system is configured as a coil.

9. The beer processing system according to claim 5, wherein the wort boiling apparatus comprises a wort kettle or coil.

10. The beer processing system according to claim 5, wherein the wort boiling apparatus comprises a High Temperature Wort Boiling kettle or coil.
